(19) United States
(12) Patent Application Publication
(10) Pub. No.: US 2013/0130020 A1
(43) Pub. Date: May 23, 2013

(54) ELECTRODE PASTE COMPOSITION, ELECTRODE FOR ELECTRONIC DEVICE USING THE SAME, AND METHOD OF MANUFACTURING THE SAME

(71) Applicants: Woon Chun Kim, Gyunggi-do (KR); Kang Heon Hur, Gyunggi-Do (KR)

(72) Inventors: Woon Chun Kim, Gyunggi-do (KR); Kang Heon Hur, Gyunggi-Do (KR)

(73) Assignee: SAMSUNG ELECTRO-MECHANICS CO., LTD., Suwon (KR)

(21) Appl. No.: 13/619,166

(22) Filed: Sep. 14, 2012

(30) Foreign Application Priority Data
Nov. 21, 2011 (KR) 10-2011-0121627
Dec. 20, 2011 (KR) 10-2011-0138525

(51) Int. Cl. H01B 1/00; B32B 5/16; B32B 15/02; H01B 1/20; B32B 9/04; B05D 5/12; B82Y 40/00; B82Y 30/00; B82Y 99/00

(52) U.S. Cl. 428/336; 428/702; 428/448; 428/457; 427/126.1; 252/512; 252/514; 977/734; 977/932; 977/810; 977/779; 977/842

(57) ABSTRACT

There is provided an electrode paste composition, an electrode for an electronic device using the same, and a method of manufacturing the same. The electrode for an electronic device includes: a substrate; a thin film layer formed on the substrate, the thin film layer including reduced graphene oxide (rGO); and an oxide layer formed between the substrate and the thin film layer. The electrode for an electronic device may have excellent uniform resistivity and electrical conductivity since the electrode is formed by coating the substrate with a solution containing graphene oxide having superior dispersibility and reducing the graphene oxide.

### CROSS-REFERENCE TO RELATED APPLICATIONS

This application claims the priority of Korean Patent Application Nos. 10-2011-0121627 filed on Nov. 21, 2011 and 10-2011-0138525 filed on Dec. 20, 2011, in the Korean Intellectual Property Office, the disclosures of which are incorporated herein by reference.

### BACKGROUND OF THE INVENTION

1. Field of the Invention

The present invention relates to an electrode paste composition having excellent uniform resistivity and electrical conductivity, an electrode for an electronic device using the same, and a method of manufacturing the same.

2. Description of the Related Art

Graphene is a material in which carbon atoms are arranged two-dimensionally. Unlike graphite, graphene is formed to be extremely thin with a structure having a single layer of carbon atoms, or two or three layers thereof.

Since graphene is flexible and transparent, as well as having very high electrical conductivity, studies into using graphene as a transparent, flexible electrode or utilizing graphene for an electron transfer material, such as an electron transfer layer in an electronic device, have been conducted.

Graphene is particularly noted as a material suitable for use in an electron transfer layer and a transparent electrode of an electronic device utilizing a photovoltaic principle of converting received light into electricity, such as a solar cell or a light detector.

Indium tin oxide (ITO) is widely used for a transparent electrode in electronic devices. However, since manufacturing costs may be increased due to price increases and the limited supply of its main material, indium (In), as well as the fact that indium tin oxide is inflexible, indium tin oxide is difficult to apply to a flexible electronic device.

To produce a graphene thin film for an electrode, a method of refining graphite using a catalyst and a wet method using graphene oxide have been employed.

As for the method of refining graphite to produce the graphene thin film, a high-quality graphene thin film may be obtained but a process procedure may be somewhat complex.

As for the method using graphene oxide, a large-area graphene thin film may easily be formed by using a spin coating process or the like.

However, the method using graphene oxide to manufacture the electrode causes electrical properties to be more degraded than is the case with the use pure graphene, and the electrode may be manufactured in small pieces instead of a single thin film, thereby deteriorating properties thereof suitable for the formation of a transparent electrode.

Meanwhile, pure graphene is difficult to disperse in a dispersive solvent, thereby deteriorating uniform resistivity of an electrode.

### SUMMARY OF THE INVENTION

An aspect of the present invention provides an electrode paste composition having excellent uniform resistivity and electrical conductivity, an electrode for an electronic device using the same, and a method of manufacturing the same.

According to an aspect of the present invention, there is provided an electrode for an electronic device, including: a substrate; a thin film layer formed on the substrate, the thin film layer including reduced graphene oxide (rGO); and an oxide layer formed between the substrate and the thin film layer.

The oxide layer may have an average thickness of 3 nm or less, and may include silicon (Si).

The substrate may be a transparent substrate, and the thin film layer may further include a metal nanostructure.

The metal nanostructure may be at least one selected from the group consisting of metal nanowires and metal nanoparticles, and a metal used in the metal nanostructure may be at least one selected from the group consisting of silver (Ag), gold (Au), and copper (Cu).

According to another aspect of the present invention, there is provided an electrode paste composition, including: graphene oxide (GO); and a metal nanostructure.

The metal nanostructure may be at least one selected from the group consisting of metal nanowires and metal nanoparticles, and a metal used in the metal nanostructure may be at least one selected from the group consisting of silver (Ag), gold (Au), and copper (Cu).

The electrode paste composition may further include a dispersant.

The dispersant may be at least one selected from the group consisting of pure water (H₂O) and a polar organic solvent, and the dispersant may be at least one selected from the group consisting of methyl alcohol and ethyl alcohol.

According to another aspect of the present invention, there is provided a method of manufacturing an electrode for an electronic device, the method including: preparing a substrate; forming a thin film layer on the substrate by using an electrode paste composition including graphene oxide (GO) and a metal nanostructure; and reducing the graphene oxide within the thin film layer.

The metal nanostructure may be at least one selected from the group consisting of metal nanowires and metal nanoparticles, and a metal used in the metal nanostructure may be at least one selected from the group consisting of silver (Ag), gold (Au), and copper (Cu).

The electrode paste composition may further include a dispersant.

The dispersant may be at least one selected from the group consisting of pure water (H₂O) and a polar organic solvent, and the dispersant may be at least one selected from the group consisting of methyl alcohol and ethyl alcohol.

The forming of the thin film layer may be performed by gravure printing or spray coating.

The reducing of the graphene oxide within the thin film layer may be performed by using at least one reducing agent selected from the group consisting of hydrogen iodide (HI), ammonia (NH₃NH₃), and hydrazine.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 shows a schematic perspective view and a schematic partial enlarged view of an electrode for an electronic device according to an embodiment of the present invention;

FIG. 2 is a schematic view of an electrode paste composition according to another embodiment of the present invention; and

FIG. 3 shows a process of manufacturing an electrode for an electronic device according to another embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of some components may be exaggerated for clarity, and the same reference numerals will be used throughout to designate the same or like components.

Embodiments of the present invention will now be described in detail with reference to the accompanying drawings.

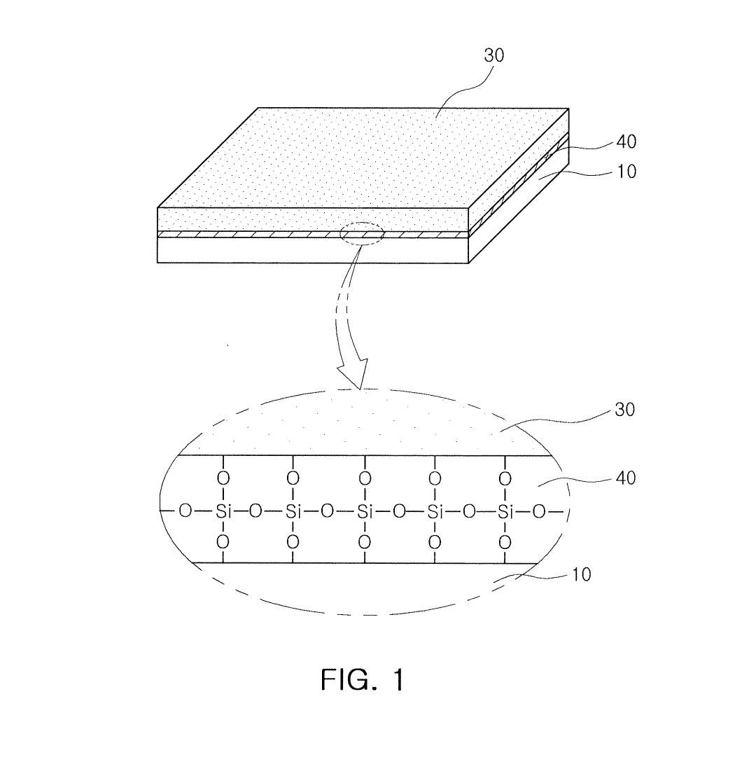

FIG. 1 shows a schematic perspective view and a schematic partial enlarged view of an electrode for an electronic device according to an embodiment of the present invention.

Referring to FIG. 1, an electrode for an electronic device according to an embodiment of the present invention may include a substrate 10; a thin film layer 30 formed on the substrate 10 and including reduced graphene oxide (rGO); and an oxide layer 40 formed between the substrate 10 and the thin film layer 30.

The substrate 10 may be a transparent substrate, and any transparent substrate may be employed for the substrate 10 without being limited thereto. For example, glass, crystal, ceramic, transparent plastic, synthetic resin, or the like may be used therefor.

According to the embodiment of the present invention, the thin film layer 30 formed on the substrate 10 may include the reduced graphene oxide (rGO).

The thin film layer 30 containing the reduced graphene oxide (rGO) may be obtained by forming a thin film oxide layer including graphene oxide on the substrate 10 and reducing the graphene oxide by using a reducing agent, as seen in a manufacturing method of the electrode for an electronic device, which will be described later.

The electrode for an electronic device according to the embodiment of the present invention includes the thin film layer including the reduced graphene oxide (rGO), so that dispersibility of the reduced graphene oxide (rGO) within the thin film layer 30 is excellent, resulting in improvement in uniform resistivity and electrical conductivity.

Specifically, the reduced graphene oxide (rGO) is a material exhibiting conductive properties, while the reduced graphene oxide (rGO) is very difficult to disperse in a solution. Therefore, in a case in which an electrode is manufactured by using the reduced graphene oxide (rGO) as it is, it may be problematic in terms of uniform resistivity.

Whereas, graphene oxide, exhibiting insulating properties, has excellent dispersibility in a solution.

However, in a case in which an electrode is manufactured by using the graphene oxide as it is, electrical properties of the electrode are deteriorated and the electrode is manufactured to have small pieces instead of a single thin film, thereby deteriorating desirable properties of the transparent electrode.

Therefore, according to the embodiment of the present invention, a thin film oxide layer including graphene oxide having excellent dispersibility is formed on the substrate 10 and the graphene oxide is reduced by using a reducing agent, thereby forming the thin film, layer 30 including the reduced graphene oxide (rGO).

The reduced graphene oxide (rGO) is a conductor, unlike graphene oxide exhibiting insulating properties, and thus, electric properties thereof is excellent and electrical conductivity thereof is also excellent.

In addition, since the reduced graphene oxide (rGO) is well dispersed within the thin film layer 30, uniform resistivity thereof may be excellent.

According to the embodiment of the present invention, the thin film layer 30 may further include a metal nanostructure.

The metal nanostructure may be, but is not particularly limited to, for example, at least one selected from the group consisting of metal nanowires and metal nanoparticles.

As such, the metal nanostructure is included within the thin film layer 30, thereby forming connections among unit structures of the reduced graphene oxide (rGO).

Specifically, the metal nanostructure connects the unit structures of the reduced graphene oxide (rGO), which have intervals thereamong within the thin film layer 30, resulting in excellent electrical conductivity.

Also, a metal material for the metal nanostructure is not particularly limited as long as it can exhibit electrical conductivity, and may be at least one selected from the group consisting of silver (Ag), gold (Au), and copper (Cu).

The electrode for an electronic device according to the embodiment of the present invention may include the oxide layer 40 formed between the substrate 10 and the thin film layer 30.

The oxide layer 40 may include silicon (Si), in particular, silicon dioxide (SiO₂).

Referring to FIG. 1, the oxide layer 40 may connect the substrate 10 and the thin film layer 30 including the reduced graphene oxide (rGO) by covalent bonds between silicon atoms and oxygen atoms.

The oxide layer 40 may be formed by treating a surface of the substrate 10 with a primer including silicon dioxide (SiO₂) during a manufacturing process of the electrode for an electronic device.

The oxide layer may have an average thickness of 3 nm, but is not particularly limited thereto.

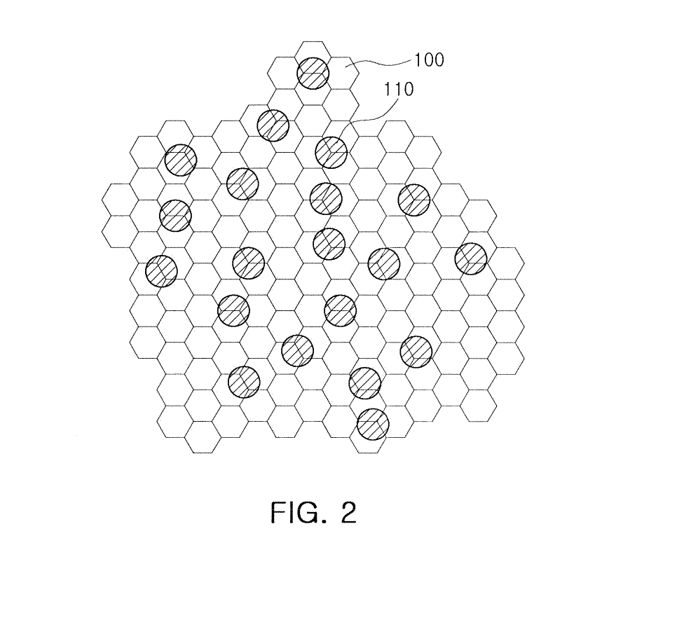

FIG. 2 is a schematic view of an electrode paste composition according to another embodiment of the present invention.

Referring to FIG. 2, an electrode paste composition according to another embodiment of the present Invention may include graphene oxide (GO) 100 and a metal nanostructure 110.

The electrode paste composition may include graphene oxide 100 having excellent dispersibility and include a metal nanostructure 110 functioning to form connections among unit structures of the graphene oxide 100.

As such, the electrode paste composition includes graphene oxide having excellent dispersibility, and thus, it may be coated on the substrate in a good dispersion condition during a manufacturing process of the electrode, resulting in excellent uniform resistivity.

Also, the electrode paste composition includes the metal nanostructure 110 forming connections among the u structures of graphene oxide, resulting in excellent electrical conductivity.

The metal nanostructure may be, but is not particularly limited to, at least one selected from the group consisting of metal nanowires and metal nanoparticles.

Also, a metal material for the metal nanostructure is not particularly limited as long as it can exhibit electrical conductivity, and may be at least one selected from the group consisting of silver (Ag), gold (Au), and copper (Cu).

The electrode paste composition may further include a dispersant.

The dispersant may be, but is not particularly limited to, at least one selected from the group consisting of pure water (H₂O) and a polar organic solvent.

Specifically, the polar organic solvent may be at least one selected from the group consisting of methyl alcohol and ethyl alcohol, but is not limited thereto.

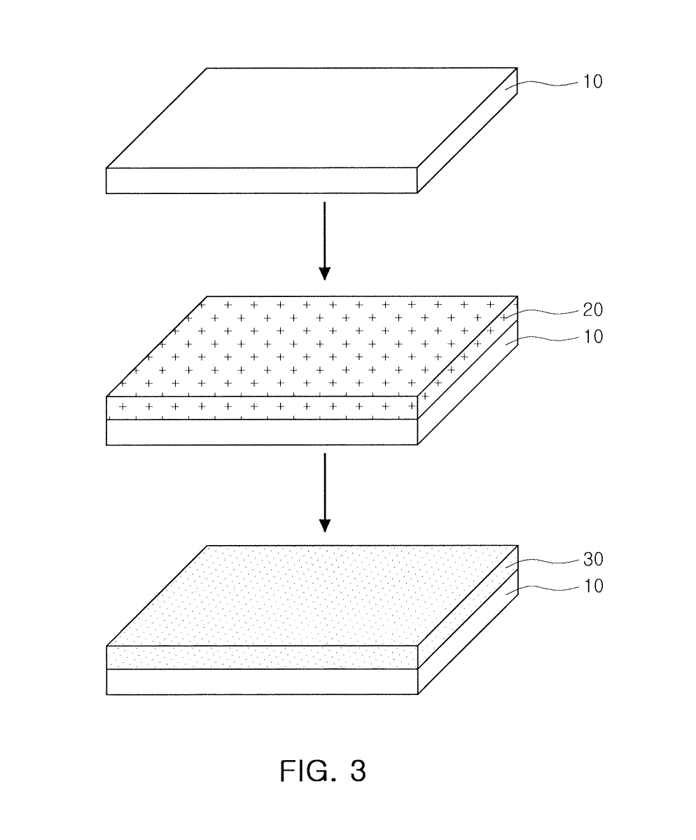

FIG. 3 shows a process of manufacturing an electrode for an electronic device according to another embodiment of the present invention.

Referring to FIG. 3, a method of manufacturing an electrode for an electronic device may include preparing a substrate 10, forming a thin film layer 20 using an electrode paste composition including graphene oxide (GO) and a metal. nanostructure; and reducing the graphene oxide within the thin film layer 20.

Hereinafter, the method of manufacturing an electrode for an electronic device according to another embodiment o: the present invention will be described in detail; however, descriptions overlapping with those of the above-described electrode for an electronic device and the electrode paste composition according to the embodiments of the present invention will be omitted.

According to the method of manufacturing the electrode for an electronic device in the present embodiment, after the substrate 10 is prepared, the thin film layer 20 may be formed on the substrate 10 by using the electrode paste composition including graphene oxide (GO) and a metal nanostructure.

The electrode paste composition may further include a dispersant.

The dispersant may be at least one selected from the group consisting of pure water (H₂O) and a polar organic solvent, and the dispersant may be at least one selected from the group consisting of methyl alcohol and ethyl alcohol, but is not particularly limited thereto.

According to the method of manufacturing the electrode for an electronic device in the present embodiment, since the electrode paste composition includes the graphene oxide 100 having excellent dispersibility, it can be coated on the substrate in a good dispersion condition at the time of manufacturing the electrode.

For this reason, the graphene oxide 100 within the thin film layer 20 is reduced by a reducing agent, such that excellent uniform resistivity can be obtained, which will be described later.

Also, the electrode paste composition includes the metal nanostructure 110 forming connections among the unit structures of graphene, resulting in excellent electrical conductivity.

The metal nanostructure may be, but is not particularly limited to, at least one selected from the group consisting of metal nanowires and metal nanoparticles.

Also, a metal material for the metal nanostructure is not particularly limited as long as it exhibits electrical conductivity, and may be at least one selected from the group consisting of silver (Ag), gold (Au), and copper (Cu).

The forming of the thin film layer may be performed by gravure printing or spray coating, but is not particularly limited thereto.

The method of manufacturing an electrode for an electronic device according to another embodiment of the present invention may include the reducing of the graphene oxide within the thin film layer 20, whereby the thin film layer 30 including the reduced graphene oxide (rGO) may be formed on the substrate 10.

The reducing of the graphene oxide 100 within the thin film layer may be performed by using a reducing agent.

Specifically, the reducing agent may be, but is not particularly limited to, at least one selected from the group consisting of hydrogen iodide (HI), ammonia (NH₃NH₃), and hydrazine.

According to the method of manufacturing an electrode for an electronic device in the present embodiment, the thin film layer 20 is formed by using the electrode paste composition containing graphene oxide (GO) and then the graphene oxide within the thin film layer 20 is reduced, whereby dispersibility of the reduced graphene oxide within the thin film layer 30 can be excellent, resulting in improvement in uniform resistivity and electrical conductivity.

Specifically, the reduced graphene oxide (rGO) is a material exhibiting conductive properties, but it is very difficult to disperse in a solution. Therefore, in a case in which an electrode is produced by using the reduced graphene oxide (rGO) as it is, it may be problematic in terms of uniform resistivity.

Whereas, graphene oxide exhibiting insulating properties has excellent dispersibility in a solution.

However, in a case in which an electrode is produced by using the graphene oxide as it is, electric properties of the electrode are deteriorated and the electrode is manufactured to have small pieces instead of a single thin film, thereby deteriorating desirable properties of the transparent electrode.

Therefore, according to another embodiment of the present invention, the thin film layer 30 including the reduced graphene oxide (rGO) may be formed on the substrate 10 by forming a thin film oxide layer including graphene oxide having excellent dispersibility on the substrate 10 and reducing the graphene oxide by using a reducing agent.

The reduced graphene oxide (rGO) is a conductor, unlike graphene oxide exhibiting insulating properties, and electric properties thereof may be excellent and electrical conductivity thereof may also be excellent.

In addition, since the reduced graphene oxide (rGO) is well dispersed within the thin film layer 30, uniform resistivity thereof can be excellent.

Also, the electrode paste composition includes the metal nanostructure 110 forming connections among unit structures of graphene, resulting in excellent electrical conductivity.

As set forth above, an electrode for an electronic device according to embodiments of the present invention is formed by coating a substrate with a solution containing graphene oxide having excellent dispersibility and reducing the graphene oxide, whereby uniform resistivity and electrical conductivity can be enhanced.

While the present invention has been shown and described in connection with the embodiments, it will be apparent to those in the art that modifications and variations can be made without departing from the spirit and scope of the invention as defined by the appended claims.

What is claimed is:

1. An electrode for an electronic device, comprising:
a substrate;
a thin film layer formed on the substrate, the thin film layer including reduced graphene oxide (rGO); and
an oxide layer formed between the substrate and the thin film layer.

2. The electrode for an electronic device of claim 1, wherein the oxide layer has an average thickness of 3 nm or less.

3. The electrode for an electronic device of claim 1, wherein the oxide layer includes silicon (Si).

4. The electrode for an electronic device of claim 1, wherein the substrate is a transparent substrate.

5. The electrode for an electronic device of claim wherein the thin film layer further includes a metal nanostructure.

6. The electrode for an electronic device of claim 5, wherein the metal nanostructure is at least one selected from the group consisting of metal nanowires and metal nanoparticles.

7. The electrode for an electronic device of claim wherein a metal used in the metal nanostructure is at least one selected from the group consisting of silver (Ag), gold (Au), and copper (Cu).

8. An electrode paste composition, comprising:
graphene oxide (GO); and
a metal nanostructure.

9. The electrode paste composition of claim 8, wherein the metal nanostructure is at least one selected from the group consisting of metal nanowires and metal nanoparticles.

10. The electrode paste composition of claim 8, wherein a metal used in the metal nanostructure is at least one selected from the group consisting of silver (Ag), gold (Au), and copper (Cu).

11. The electrode paste composition of claim 8, further comprising a dispersant.

12. The electrode paste composition of claim 11, wherein the dispersant is at least one selected from the group consisting of pure water (H₂O) and a polar organic solvent.

13. The electrode paste composition of claim 11, wherein the dispersant is at least one selected from the group consisting of methyl alcohol and ethyl alcohol.

14. A method of manufacturing an electrode for an electronic device, the method comprising:
preparing a substrate;
forming a thin film layer on the substrate by using an electrode paste composition including graphene oxide (GO) and a metal nanostructure; and
reducing the graphene oxide within the thin film layer.

15. The method of claim 14, wherein the metal nanostructure is at least one selected from the group consisting of metal nanowires and metal nanoparticles.

16. The method of claim 14, wherein a metal used in the metal nanostructure is at least one selected from the group consisting of silver (Ag), gold (Au), and copper (Cu).

17. The method of claim 14, wherein the electrode paste composition further includes a dispersant.

18. The method of claim 17, wherein the dispersant is at least one selected from the group consisting of pure water (H₂O) and a polar organic solvent.

19. The method of claim 17, wherein the dispersant is at least one selected from the group consisting of methyl alcohol and ethyl alcohol.

20. The method of claim 14, wherein. the forming of the thin film layer is performed by gravure printing or spray coating.

21. The method of claim 14, wherein the reducing of the graphene oxide within the thin film layer is performed by using at least one reducing agent selected from the group consisting of hydrogen iodide (HI), ammonia (NH₃NH₃), and hydrazine.
